(19) United States
(12) Patent Application Publication
(10) Pub. No.: US 2025/0342046 A1
(43) Pub. Date: Nov. 6, 2025

(54) Methods and Systems for Obtaining Content and Fetching Dynamic Attributes for a Contextual User Interface

(71) Applicant: T-Mobile Innovations LLC, Overland Park, KS (US)

(72) Inventors: Rohit IYER, Renton, WA (US); Bala Subrahmanya Vivek KOSANAM, Auburn, WA (US); Alexander Clinton LAMBERT, Issaquah, WA (US); Sean Harrison ROACH, Kenmore, WA (US); Sajith SANKARANARAYANAN, Overland Park, KS (US); Dhananjay WADHWA, Renton, WA (US)

(21) Appl. No.: 18/653,899

(22) Filed: May 2, 2024

(51) Int. Cl. G06F 9/451; G06F 16/958

(52) U.S. Cl. CPC G06F 9/451; G06F 16/958

(57) ABSTRACT

A controller application is configured to determine content for a contextual user interface to be displayed at a client based on a page requested by the client, wherein the content includes a first plurality of cards of a first quantity, identify a segment associated with the client, wherein the segment comprises a grouping of different clients based on a shared characteristic between the plurality of different clients, filter the content to obtain filtered content based on the segment, wherein the filtered content includes a second plurality of cards of a second quantity, determine dynamic attributes that are to be obtained from one or more external sources in based on metadata of the second plurality of cards, receive the dynamic attributes from the external sources in a single pass, and transmit rendering parameters to the client for the client to render the contextual user interface based on the rendering parameters.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A client (e.g., an electronic device) may display a user interface on a webpage (or page) of an application displayed on a screen of the client. The content within the webpage may typically be consistent across all of the different clients accessing the same webpage. For example, a homepage of a telecommunications service provider company may generally be the same across different devices operated by different subscribers of the company. Even when the homepage is displayed after the subscriber is authenticated with a core network of the company (e.g., using a login and password), the homepage may still be displayed in the same manner across different user devices with the similar content. The content displayed at the homepage may include modular components, templates, and pages, which may be created by authors as reusable components, such as text and/or images.

### SUMMARY

In an embodiment, a method implemented in a communication network to provide a contextual user interface to a client is disclosed. The method comprises receiving, by a controller application implemented at a system in the communication network, from a client, a request for a page to be displayed at the client, in which the request comprises an identifier of the client, and determining, by the controller application, content to display in the contextual user interface based on the page indicated in the request, wherein the content includes a first plurality of cards of a first quantity. The method comprises identifying, by the controller application, a segment associated with the client, in which the segment comprises a grouping of a plurality of different clients based on a shared characteristic between the plurality of different clients, and identifying, by the controller application, a rule for displaying at least a portion of the content at the client, in which the rule indicates one or more conditions for the portion of content to be included in the contextual user interface. The method further comprises filtering, by the controller application, the content to obtain filtered content based on at least one of the segment or the rule, the filtered content including a second plurality of cards of a second quantity, and the first quantity is greater than the second quantity, and determining, by the controller application, one or more dynamic attributes that are to be obtained from one or more external sources in the communication network based on metadata of the second plurality of cards. The method further comprises receiving, by the controller application, the one or more dynamic attributes from the one or more external sources in a single pass, and transmitting, by the controller application, rendering parameters to the client for the client to render the contextual user interface based on the rendering parameters, wherein the rendering parameters indicate the filtered content and the one or more dynamic attributes.

In another embodiment, a method implemented in a communication network to provide a contextual user interface to a client is disclosed. The method comprises determining, by a controller application implemented at a system in the communication network, content for a contextual user interface to be displayed at a client based on a page requested by the client, in which the content includes a first plurality of cards of a first quantity, and identifying, by the controller application, a segment associated with the client, the segment comprising a grouping of a plurality of different clients based on a shared characteristic between the plurality of different clients. The method further comprises filtering, by the controller application, the content to obtain filtered content based on the segment, the filtered content including a second plurality of cards of a second quantity, and the first quantity being greater than the second quantity, and determining, by the controller application, one or more dynamic attributes that are to be obtained from one or more external sources in the communication network based on metadata of the second plurality of cards. The method further comprises receiving, by the controller application, the one or more dynamic attributes from the one or more external sources in a single pass, and transmitting, by the controller application, rendering parameters to the client for the client to render the contextual user interface based on the rendering parameters, in which the rendering parameters indicate the filtered content and the one or more dynamic attributes.

In yet another embodiment, a system comprises at least one data store configured to store a parameter, at least one processor, at least one memory coupled to the processor, and a controller application stored in the at least one memory. The controller application, when executed by the at least one processor, cause the controller application to be configured to determine content for a contextual user interface to be displayed at a client based on a page requested by the client, wherein the content includes a first plurality of cards of a first quantity, identify a segment associated with the client, wherein the segment comprises a grouping of a plurality of different clients based on a shared characteristic between the plurality of different clients, filter the content to obtain filtered content based on the segment, wherein the filtered content includes a second plurality of cards of a second quantity, wherein the first quantity is greater than the second quantity, determine one or more dynamic attributes that are to be obtained from one or more external sources in based on metadata of the second plurality of cards, receive the one or more dynamic attributes from the one or more external sources in a single pass, and transmit rendering parameters to the client for the client to render the contextual user interface based on the rendering parameters, wherein the rendering parameters indicate the filtered content and the one or more dynamic attributes.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIGS. 2A-C are message sequence diagrams illustrating communications in the communication system of FIG. 1 directed to generating and providing a contextual user interface to a client according to various embodiments of the disclosure.

FIG. 3 is a flowchart of a first method of generating and providing a contextual user interface to a client according to various embodiments of the disclosure.

FIG. 4 is a flowchart of a second method of generating and providing a contextual user interface to a client according to various embodiments of the disclosure.

FIG. 5 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, the term “client” may refer to a device operated by the user and/or the user operating the device. The same user may operate different devices to access webpages or an application after providing user credentials via the device to an authentication server. Therefore, the term “client” may in some cases broadly refer to a user operating any type of device, or may refer to the device itself operated by a particular user. The term “context” may refer to situational factors and attributes associated with the user, the device operated by the user, and/or the user/client interacts with a system, as further described herein.

The embodiments of the present disclosure are directed to generating user interface displays including one or more cards that include various types of attributes, all of which may be based on a context of a client. Definitions of the aforementioned terms are further described herein.

As mentioned above, pages (e.g., webpages on a browser or pages of an application) may include a user interface with multiple components that may be displayed on a screen of a client (e.g., an electronic device). The user interface may encompass all of the visual and interactive elements that a user may view and interact with on a screen of the client. The elements may include buttons, forms, menus, images, text, and any other component that facilitates user interaction and communication through the page. To this end, the user interface may include one or more cards (sometimes referred to herein as “card components”). Each card may be a data and/or software artifact that is a modular container used to display specific content, functions, or information on the page, and each card may include distinct sections for various elements, such as text, images, buttons, etc., providing a structured and visually cohesive presentation. For example, each card may be authored by one or more applications or users, and then saved to a content server, such that the cards may be used by various systems for display in different types of pages. Systems may obtain the cards from the content server and then generate pages and user interfaces including the cards.

In some cases, different cards may be positioned within the user interface of the page based on a predefined layout, whereby certain cards are preset to be positioned at certain locations of the layout. For example, the layout may be a grid layout, or a design structure that organizes content on a webpage into a series of consistent or inconsistent rows and columns. In this way, the page may include predefined content in terms of the cards that are included in the user interface of the page and the layout of the cards displayed within the user interface.

In some cases, the content displayed in the user interface may include dynamic attributes, or data specific to a user or a context of a user operating the client. The card may include a placeholder component for the dynamic attributes, but may not include the actual dynamic attributes since the dynamic attributes may be different across different clients. Instead, the dynamic attributes may need to be obtained (e.g., internally or sometimes from an external source) and then input into the card for display. In some cases, the client may need to be authenticated (e.g., login with authentication credentials) before the dynamic attributes may be obtained and input into the card to be displayed at the client. In this way, the user interface displayed on a page may include dynamic attributes specific to a client (or a user operating the client) and/or static attributes that may be consistently displayed across different clients.

The general content displayed on the user interface and an ordering/layout of the content may be consistent across different clients for the same page, even when the user interface includes dynamic attributes specific to the user/client and/or a context of the user/client. That is, the information displayed at the user interface for a page is not customized or personalized to the client, the user operating the client, a user account of the client, attributes of the client/user, categorizations of the client/user, etc. Because the information displayed at a page may be more or less consistent across devices, a user may have to interact with the user interface displayed at the client (e.g., the user may have to click different links/buttons/etc.) to display multiple different pages and user interfaces until a page providing relevant, desired information is finally presented to the user. In other words, the lack of personalization and customization of the page creates a heavy load at the client itself and over the network because content may be received and displayed at the client in multiple iterations of pages before desired information is finally displayed. Therefore, page generation and display at a client may be inefficient and ineffective, in that the reception and rendering of multiple different pages unnecessarily may consume processing power at the client while reducing capacity at the network. Moreover, the dynamic attributes that are capable of being input into a card may be limited in some cases to only internal sources accessible by an application developing the page and user interface, thereby significantly limiting the information that may be displayed at the page.

As described herein and in the co-pending U.S. patent application Ser. No. 18/642,662, filed Apr. 22, 2024, by Rohit lyer, et. al., entitled “Methods and Systems for Providing a Contextual User Interface to a Client,” is disclosed. A communication network implementing these embodiments may include, for example, the client, a system including a controller application, a server storing relevant data, a content server storing content for the contextual user interface, and one or more external sources storing dynamic attributes for the contextual user interface. The controller application may generate parameters for a contextual user interface on a page for display at the client, in which the contextual user interface displays content that is not only specifically based on user data, client data, and historical data associated with each, but also based on a context of the user or client.

A context of the user or client may in some cases refer to a comprehensive set of situational factors and attributes associated with the user, the client, and the user/client interacts with a system. The context may extend beyond historical data associated with the user and the client and may include real-time elements such as, for example, a location of the client, a time/day/month, personal interests and preferences of the user, etc. The context of a client and/or the user operating the client may thus refer to data related to a holistic analysis of both the client and the user, which may be used to generate a contextual user interface that anticipates user needs and delivers personalized content and/or services to the client accordingly. In some cases, the context of the user and client may be specifically based on information that only certain entities may have access to (e.g., in a secured data store of an entity). For example, the entity may be a wireless communication service provider, and the data store may be a subscription and/or account data store. To this end, the contextual user interface disclosed herein may be personalized or customized for the client and/or the user operating the client based on various factors, as further described herein. The contextual interface may include client-specific content (e.g., cards), which may be positioned on the user interface in a particular order and/or layout specifically for the client and/or user operating the client. In this way, the contextual user interface may provide the most contextually relevant and desired data to the user at the client, thereby preventing the user from having to browse through various, undesired pages to display the most contextually relevant and desired data to the user.

However, in some cases, the process of obtaining data that is used to generate and render the contextual user interface may involve a heavy consumption of resources across all of the systems and servers in the communication network and a heavy load in the communication network. More specifically, the processing of obtaining content for the contextual user interface from a content server in the communication network may involve the receiving of irrelevant cards (i.e., cards with content that may not interest a user of the client). Similarly, the process of obtaining the dynamic attributes from the external sources in the communication network may sometimes involve redundantly requesting the same information (e.g., dynamic attributes across different cards) from multiple different external sources, and then redundantly receiving the same dynamic attributes from the multiple different external sources. Thus, the process of obtaining the content from the content server and the dynamic attributes from the external sources may lead to technical problems, such as network congestion, reduced processing power at the system generating the contextual user interface, etc.

The present disclosure addresses the foregoing technical problems by providing a technical solution in the technical field of webpage/application page generation and rendering at the client. In some embodiments, the controller application that generates parameters defining the contextual user interface may also be responsible for filtering content received from the content server for a requested page, and intelligently obtaining dynamic attributes for a contextual user interface from different external sources while eliminating redundancies. By preventing the transmission and rendering of the undesired content and redundant dynamic attributes, the processing load and power consumption at the system and client may be reduced. Similarly, the network load that may have otherwise been used to provide the undesired content and redundant dynamic attributes to the system may also be reduced, thereby increasing capacity in the communication network.

As described herein, the controller application in the system may be responsible for obtaining (e.g., determining and/or receiving) the content for the contextual user interface in response to a page requested by the client. In doing so, the controller application may filter the content before actually receiving the content from the content server. First, the controller application may determine the content to include in the contextual user interface for a requested page. This determination may be performed based on a locally accessible data store, which indicates the content that may be associated with a requested page (e.g., in a list or table). Alternatively, this determination may be performed by communicating with the content server, in which the content server provides a list or some other indication of the content that is associated with the requested page.

For example, the determined content may include a first quantity of cards, which in some cases may be based on preset, default cards associated with the requested page. As mentioned above, each card may be a data and/or software artifact that is a modular container used to display specific content, functions, or information on the page. Each card may include distinct sections for various elements, such as text, images, buttons, etc., providing a structured and visually cohesive presentation. For example, each card may group several distinct (but related) pieces of information together into one unit (e.g., an article on a news website, a product an ecommerce site, a post on a social media application). A single card may include multiple different types of media, such as, for example, an image, a title, a synopsis, other icons/buttons associated with a common concept.

The controller application may identify the segments, rules, lists of segment-based content, and/or lists of rule-based content applicable to the client and/or the requested page. In doing so, the controller application may communicate with the server to obtain the segments, rules, lists of segment-based content, and/or lists of rule-based content applicable to the client and/or the requested page, which may then be transmitted back to the controller application for identification. The applicable segments and/or rules may be stored at a data store in a server external to the system, but communicatively coupled to the system. Alternatively, the system may include the server storing the segments and rules.

A segment may refer to a logical grouping of clients based on various factors, such as, for example, an account associated with client (e.g., billing, subscription plans, etc.), similar consumption histories (e.g., click history, page history, etc.), similar purchase histories (e.g., prior purchases mobile phones, tablets, etc.), personal information of the user (e.g., age, gender, occupation, etc.), and/or any other type of data that may be used to group together clients associated with different users. In an embodiment, the content (e.g., cards) may include metadata or tags identifying segments of clients that are applicable or associated with the content. Each segment may be identified by a segment identifier (e.g., a value or code) uniquely identifying a segment. The content may be tagged with the segment identifiers of segments associated with the content. In the same way, user data describing a client/user may also be tagged with segment identifiers, each identifying a segment applying to the client/user. For example, a user account may include segment identifier associated with a particular age group, and a card may be tagged with the same segment identifier.

As further described herein, a controller application may obtain the content from the content server, determine the segment identifiers associated with the content, and then determine whether the requesting client is tagged with the same segment identifiers. The client may be tagged with the same segment identifier when user data associated with the client indicates the same segment identifier. When the client is tagged with the same segment identifier as the content, the controller application may add the content to the contextual user interface for the client.

In another embodiment, a data store may maintain an organized listing of the clients in each segment and a listing of the associated content that may be relevant to/likely to be consumed by the clients in each segment. In this case, each segment may be stored at the data store and include one or more client identifiers identifying clients that are part of the segment and may include data describing the grouping. Each segment may also be stored in association with a list of segment-based content, which may include pointers to content at the content server that may be relevant or likely to be consumed by the clients of the segment. For example, a segment may be related to college students of a particular university. The stored segment may include identifiers identifying the clients of the college students. The corresponding list of segment-based content may include offers, for example, for streaming access to sporting events of the university. This content itself may be stored at the content server, while pointers to this content may be stored in the content server as the list of segment-based content in association with the segment.

A rule may refer to one or more conditions that may be met to display content in the contextual user interface. Each rule stored at the data store may include logic or code corresponding to each of the conditions. Each rule may be based on various factors, such as, for example, an account associated with a client, a consumption history at the client, a purchase history at the client, personal information of the user, and/or any other type of data related to the client and/or user. In an embodiment, the controller application may determine rules that apply to combinations of content and requesting clients, and then determine whether to add certain content to the contextual user interface for the user based on the rule.

For example, a rule may indicate that when the payment contract for the client is expiring (e.g., first condition) and when the client has accessed a page related to a newly released device (e.g., second condition), an advertisement or offer for the newly released device (e.g., content) may be indicated to be included in the contextual user interface for the client. To this end, the rule may include logic or code for the first condition and the second condition. In this case, the controller application may determine that the payment contract for a requesting client meets the first condition, and that content received for a requested page meets the second condition. The controller application may then determine that the content, or other content is to be included in the contextual user interface for the client.

In some cases, each rule may also be associated with a list of rule-based content, which may include pointers to content at the content server. For example, the rule may indicate that when the first condition and the second condition are met, particular rule-based content may be included in the contextual user interface for the client. A corresponding list of rule-based content, based on the satisfaction of various conditions in the rule, may include a pointer to particular pieces of content at the content server.

At this stage, the controller application may retrieve the content associated with the requested page, and may have identified the applicable segments, rules, lists of segment-based content, and/or lists of rule-based content. In other words, the controller application may examine the content retrieved to identify segments and determine rules that apply to the content based on the requesting client and the content itself.

The controller application may then filter the determined content based on the applicable segments and/or lists of segment-based content to obtain filtered content. For example, the controller application may filter certain cards out of the determined content when the cards are not tagged with segments (e.g., include segment identifiers) that are relevant to the client requesting the content. In the same way, the controller application may only select the cards out of the determined content that are tagged with the segments (e.g., include segment identifiers) that are relevant to the client requesting the content. In another example, the segments and lists of segment-based content may indicate the type of content that may be the most relevant to the user and/or client based on a categorical grouping of the user and/or client.

The controller application may similarly filter the determined content based on the applicable rules and/or lists of rule-based content to obtain filtered content. For example, the controller application may filter certain cards out of the determine content when the rules that are applicable to the card and the content do not instruct the cards to be included in the contextual user interface. In the same way, the controller application may only select the cards out of the determined content that are determined to be included in the contextual user interface for the client based on rules applicable to the card and the content. In another example, the rules and/or lists of rule-based content may indicate the type of content that is most relevant to the user and/or client based on a state and/or attributes of the user and/or client. The controller application may in some cases use a predictive model, which may be trained to further predict whether certain types of content are likely to be relevant and interesting to the user, and thus may be included in the contextual user interface or should be excluded from the contextual user interface.

The controller application may then determine the dynamic attributes in the filtered content that are to be obtained from different external sources. This determination may be performed based on the in the filtered content. For example, each card in the filtered content may include placeholders, tags, or metadata indicating the dynamic attributes that are to be received from an external source and input into the card. The controller application may obtain, for example, a list of all dynamic attributes in the filtered content by examining all of the placeholders, tags, and metadata for all of the cards in the filtered content. The controller application may review the list of all dynamic attributes to determine redundancies across the different cards in the filtered content. The controller application may group redundant dynamic attributes for different cards together when the dynamic attributes describe identical types of data. For example, multiple different cards may have a common dynamic attribute related to a location of the client. The controller application may determine that the different cards that each include the location-related dynamic attribute, and then group these attributes together such that the location-related attribute may be obtained in a single pass from a single external source. The controller application may then obtain (e.g., receive) from the single external source the dynamic attribute (e.g., the location-related dynamic attribute) for all of the different cards.

In this way, the controller application may consolidate the dynamic attributes across all of the different cards when multiple cards have overlapping dynamic attributes, which may be used differently for the different cards, but may be the same for a single client. By consolidating the process of retrieving common dynamic attributes for the filtered content, the load on the network may be significantly reduced since the redundant transmissions of the common dynamic attributes from the external sources to the system can be reduced.

Therefore, the embodiments disclosed herein display at the client a customized and personal page, with a contextual user interface that is intelligently built to filter out irrelevant data (e.g., in the form of cards) and add relevant data. The content and dynamic attributes input into the contextual user interface are obtained from different servers and sources in a far more resource and network efficient manner. Thus, as described above, the embodiments disclosed herein prevent unnecessary traffic from flooding the network, and prevent the system from having to include content that may not necessarily be interesting to the user in the contextual user interface.

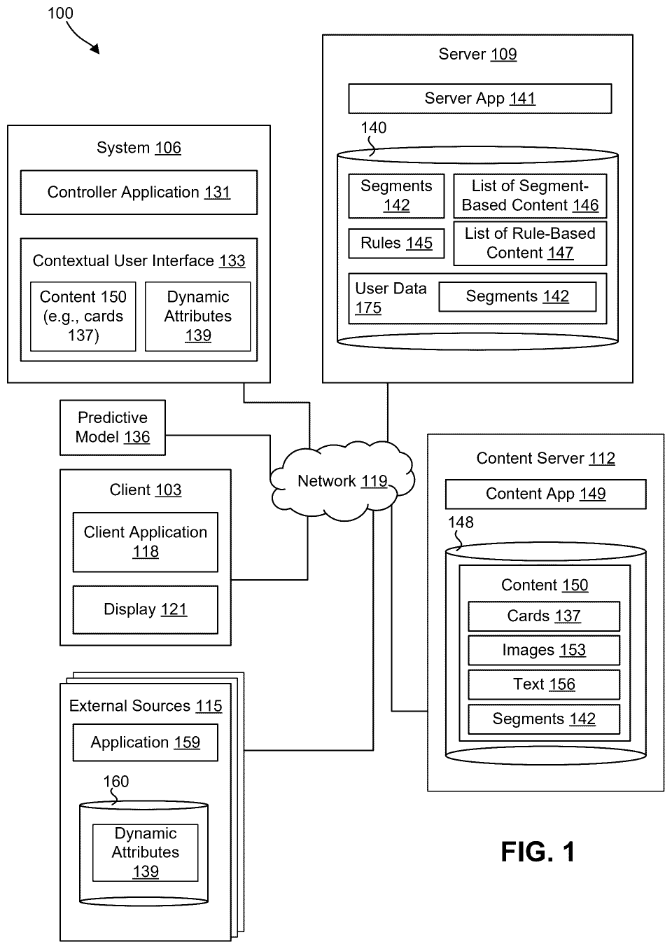

Turning now to FIG. 1, a communication network 100 is described. The communication network 100 comprises a client 103, a system 106, a server 109, a content server 112, one or more external sources 115, and network 119. The client 103, system 106, server 109, content server 112, external sources 115, and network 119 may be interconnected by wired or wireless communication links. In some cases, the client 103 may communicate with the system 106 via a wireless link implemented by a cell site. The cell site may provide a wireless communication link to the client 103 according to a 5G, a long term evolution (LTE), a code division multiple access (CDMA), or a global system for mobile communications (GSM) wireless telecommunication protocol. The network 119 may be one or more private networks, one or more public networks, or a combination thereof. While the system 106, server 109, content server 112, and external sources 115 are displayed in FIG. 1 as being external to the network 119, it should be appreciated that in some embodiments, the system 106, server 109, content server 112, and external sources 115 may be part of the network 119.

A client 103 may be a user equipment (UE) or any type of device with a display 121 for displaying a contextual user interface 133. For example, the client 103 may be a cell phone, a mobile phone, a smart phone, a personal digital assistant (PDA), an Internet of things (IoT) device, a wearable computer, a headset computer, a laptop computer, a tablet computer, or a notebook computer. The client 103 may include a display 121 (e.g., a screen) for displaying a contextual user interface 133, as further described herein. The client 103 may include a client application 118, which may include instructions stored on a non-transitory memory of the client 103 that when executed by a processor of the client 103, causes the client 103 to perform various steps as further disclosed herein.

The system 106 may be a computer system, server software/hardware, or a collection of processors, memories, and/or networking resources, used to implement a controller application 131. For example, the system 106 may be a cloud-based system, located at a data center or distributed across multiple data centers. The controller application 131 may include instructions stored on a non-transitory memory of the system 106 that when executed by a processor of the system 106, causes the system 106 to perform various steps as further disclosed herein. As further described herein, the controller application 131 obtains (e.g., receives) the content 150 for a requested page, processes the content 150 (e.g., filters the content 150 and/or adds new content 150) based on various factors, generates various parameters related to the display and rendering of a contextual user interface 133 including the content 150, and transmits the parameters and content 150 to the client 103 for display. The contextual user interface 133 may include content 150, such as, for example cards 137, images 153, texts 156, other pages, asserts, and/or any other data/visual element. The content 150 may include dynamic attributes 139, or user-specific data obtained from external sources 115.

In an embodiment, the content 150 displayed in the contextual user interface 133 may be determined using, at least in part, a predictive model 136. As shown in FIG. 1, the predictive model 136 may be separate from the system 106. For example, the predictive model 136 may be located in a server or system external to the system 106, and the system 106 may be communicatively coupled to the external server or system. The system 106 may have secured access to the predictive model 136 in this embodiment.

The predictive model 136 may be implemented using software (e.g., data, algorithms, logic, and code) stored across one or more memories. In an embodiment, the underlying hardware of the system 106 may provide the computational resources for execution of the predictive model 136. In another embodiment, one or more servers external to the system 106 and/or even the communication network 100 may include the hardware and software resources for execution of the predictive model 136. For example, the predictive model 136 may be a type of machine learning model that leverages algorithms and statistical techniques to analyze input features, identify patterns, and generate predicted content 150 that is likely to be consumed at the client 103. The predictive model 136 may be implemented as one or more different types of models using, for example, linear regression, decision trees, support vector machines, neural networks, or ensemble methods. It should be appreciated that any type of predictive model may be used, and the underlying algorithms, computations, and machine learning libraries used by the predictive model 136 should not be limited herein.

The predictive model 136 may be trained using various types of data related to the client 103, such as, for example, a history of pages accessed by the client 103 (and/or other clients operated by the user), which may be used to predict content 150 that is not only relevant to a page request by the client 103, but also likely to be consumed (e.g., interacted with) at the client 103 by the user. The predictive model 136 may be trained to also predict a context of the user and/or client 103 based on known data related to the user and/or client 103, and the context of the user may be used to predict content 150, as mentioned above. The predictive model 136 may be trained based on known outcomes of whether certain prior content 150 presented at the client 103, based on certain contexts, was consumed or ignored by the user based on, for example, whether the user previously clicked the links/data in the prior content 150. The predictive model 136 may be trained using client data, user data, account data, and historical data, and in some cases, based on hundreds or thousands of historical data points associated with the client 103. The data points and algorithms in the predictive model 136 may be used to make predictions about types of content 150 that, when presented at the client 103, are likely to be relevant and consumed at the client 103. For example, the predictive model 136 may identify patterns of consumption or interest behavior at the client 103 based on the data points and algorithms in the predictive model 136.

The server 109 may be a computer system, server software/hardware, or a collection of processors, memories, and/or networking resources, and in some cases, may be cloud-based and implemented across one or more data centers. The server 109 may include a server application 141, which may include instructions stored on a non-transitory memory of the server 109. The server application 141 may be executed by a processor of the server 109 to perform various steps, as further described herein.

The server 109 may also include a data store 140. The data store 140 may store data related to different users and/or clients 103 that may be associated with a service (e.g., registered customers of a telecommunications service provider). As shown in FIG. 1, the data store 140 may store segments 142, associated lists of segment-based content 146, rules 145, associated lists of rule-based content 147, and/or other data related to different users and/or clients 103. The segment 142 may be a logical grouping of clients 103 based on various factors, such as, for example, an account associated with client 103 (e.g., billing, subscription plans, etc.), similar consumption histories (e.g., click history, page history, etc.), similar purchase histories (e.g., prior purchases of mobile phones, tablets, etc.), personal information of the user (e.g., age, gender, occupation, etc.), and/or any other type of data that may be used to group together clients 103 associated with different users. Each segment 142 stored at the data store 140 may include one or more client identifiers identifying clients 103 that are associated with the segment 142 and may include data describing the grouping. Each segment 142 may be stored in association with a list of segment-based content 146, which may be pointers to content 150 at the content server 112 that may be relevant or likely to be consumed by the clients 103 of the segment 142.

The data store 140 may also store user data 175. The user data 175 may include user account data for clients/users registered with the system 106 and/or the server 109. For example, the user data 175 may include basic information (e.g., name, username, email address, phone number, etc.), authentication data (e.g., passwords, security questions and answers, etc.), profile information (e.g., bio, gender, date of birth, location of residence, etc.), contact information (e.g., address, links to social media profiles, etc.), subscription plans and preferences, activity and usage data (e.g., login history, usage patterns, history of interactions with the platform, etc.), billing information, security information, etc. The user data 175 for a particular client 103 may also identify the segments 142 associated with the 103 based on, for example, the other data stored in the user data 175 for the client 103.

A rule 145 may include one or more conditions that, when satisfied, may indicate to display certain types of content 150 in the contextual user interface 133. Each rule 145 stored at the data store 140 may include logic or code corresponding to each of the conditions. Each rule 145 may be based on various factors, such as, for example, an account associated with client 103, a consumption history at the client 103, a purchase history at the client 103, personal information of the user, and/or any other type of data related to the client 103 and/or user. Each rule 145 may also be associated with a list of rule-based content 147, which may be pointers to certain content 150 at the content server 112.

The content server 112 may be a computer system, server software/hardware, or a collection of processors, memories, and/or networking resources, and in some cases, may be cloud-based and implemented across one or more data centers. The content server 112 may include a content application 149, which may include instructions stored on a non-transitory memory of content server 112. The content application 149 may be executed by a processor of the content server 112 to perform various steps, as further described herein. The content server 112 may also include a data store 148, storing the content 150, which may include, for example, cards 137, images 153, text 156, and/or other forms of content 150 not limited herein. For example, the content 150 may also be in the form of templates, user interface components, and pages, with different types of visual elements. As mentioned above, each card 137 may be a data and/or software artifact that is a modular container used to display specific content, functions, or information on the page. Authors may generate the content 150 and store the content 150 at the content server 112. The content 150 at the content server 112 may each be tagged to indicate segments 142 associated with the content 150.

The content 150 may include static attributes the are consistent across different clients 103 and placeholders for dynamic attributes 139 that are different across different clients 103. As mentioned above, dynamic attributes 139 may be user-specific data that may be input into the content 150 after being retrieved from an external source 115. The content 150 may also include tags or metadata describing the data displayed in the content 150 and/or indicating the dynamic attributes 139 that may have to be input into the content 150.

The external sources 115 may be a computer system, server software/hardware, or a collection of processors, memories, and/or networking resources, and in some cases, may be cloud-based and implemented across one or more data centers. The external sources 115 may each include an application 159, which may include instructions stored on a non-transitory memory of the respective external source 115. The application 159 may be executed by a processor of the external source 115 to perform various steps, as further described herein. The external sources 115 may each include a data store 160 that may store the dynamic attributes 139. In some cases, the external sources 115 may first authenticate the client 103, for example, by receiving authentication credentials (e.g., username and password), prior to the controller application 131 being able to retrieve the dynamic attributes 139 from the external sources 115.

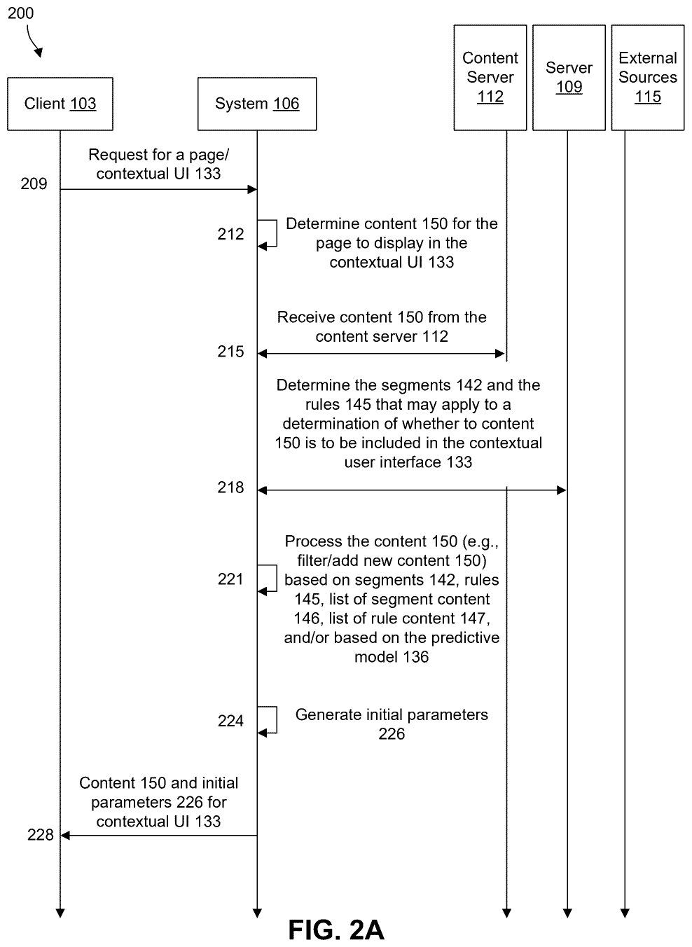

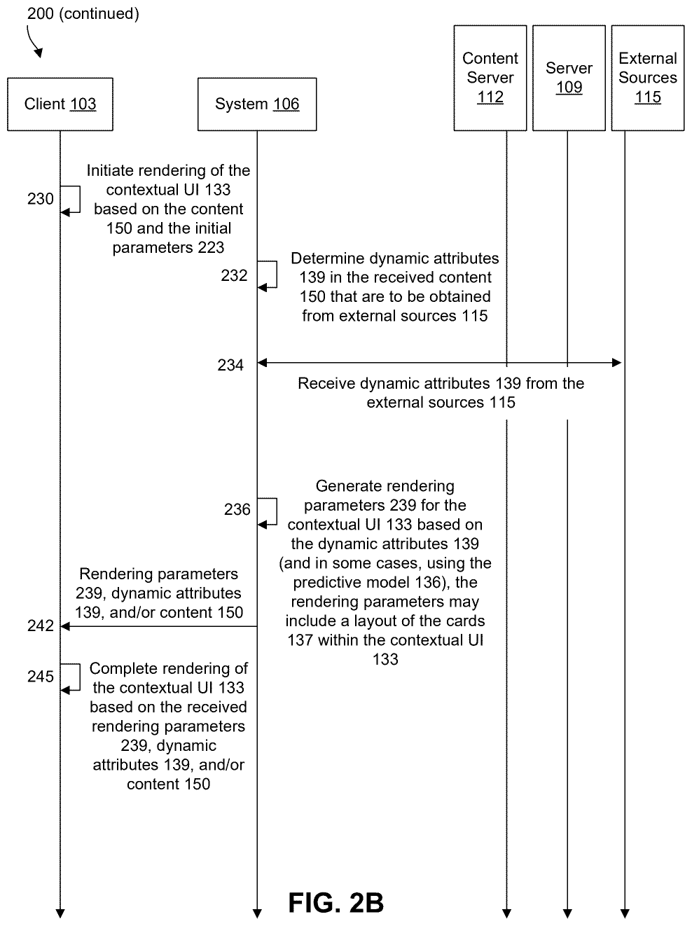

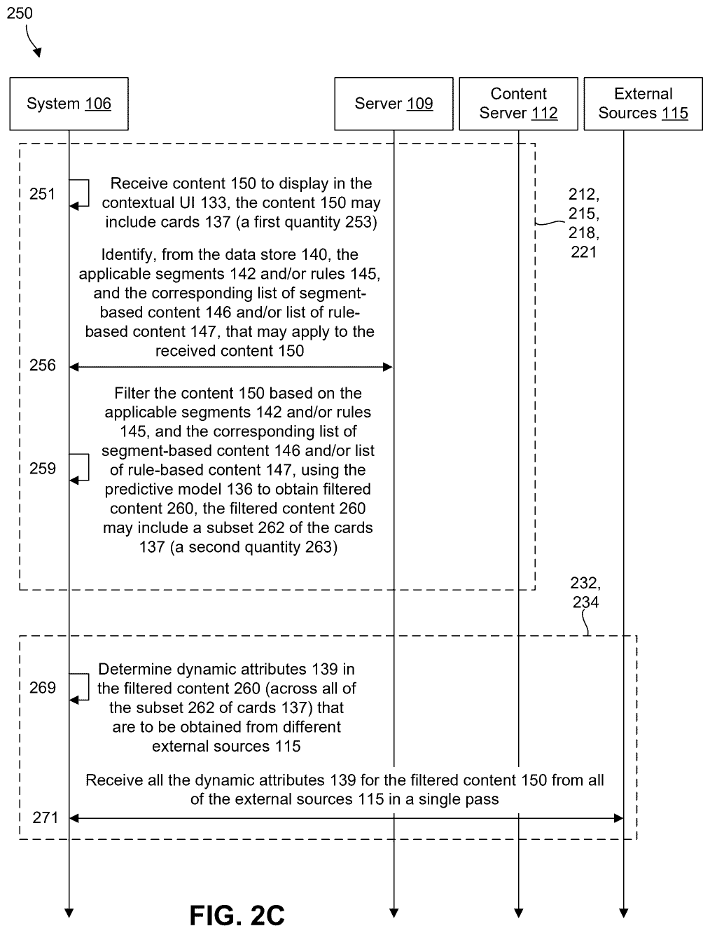

Turning now to FIGS. 2A-C, shown are message sequence diagrams illustrating communications between the client 103, system 106, the server 109, the content server 112, and one or more external sources 115. Specifically, FIGS. 2A-B illustrate communications between the client 103, system 106, the server 109, the content server 112, and one or more external sources 115 for generating the contextual user interface 133 and providing the contextual user interface 133 to the client 103. Meanwhile, FIG. 2C illustrates communications between the system 106, the server 109, the content server 112, and one or more external sources 115 for obtaining, filtering, and processing content 150 to be included in the contextual user interface 133.

Referring now to FIG. 2A, shown is a message sequence diagram illustrating a first part of method 200 for generating the contextual user interface 133 and providing the contextual user interface 133 to the client 103. Method 200 may be performed after the client 103 has provided credentials for authenticating the client 103 with a system or network associated with the system 106 (e.g., a core network associated with a telecommunications service provider).

Method 200 may begin with step 209, in which the client 103 transmits a request to the system 106. The request may be for a page (e.g., webpage or application page, homepage of the telecommunications service provider after logging into the account, etc.), and may include an indicator that the client 103 requests the page to be displayed as a contextual user interface 133 (e.g., one which is personalized for the user operating the client 103). The request may include, for example, an identifier and/or address of the client 103. The request may also include an identifier or address of the system 106.

At step 212, the controller application 131 at the system 106 may then determine content 150 to retrieve from the content server 112 for the requested page. For example, the controller application 131 may determine preset content 150 that may be associated with the requested page, in which the preset content 150 for a page may be indicated in a data store accessible by the controller application 131 or indicated in the server 109. At step 215, the controller application 131 may receive the content 150 from the content server 112. For example, the controller application 131 may transmit a request for the determined content 150 to the content server 112. The content application 149 may obtain the requested content 150 (e.g., the cards 137, the images 153, the text 156, etc.) from the data store 148, and provide the requested content 150, including the tags and metadata included with the content 150, back to the controller application 131. Alternatively, the content application 149 may provide an indication of data included in the requested content 150, such as, for example, data included in the cards 137, as opposed to providing the requested content 150 back to the controller application 131. The indication of the data included in the requested content 150 may be significantly smaller in size than the content 150 itself.

At step 218, the controller application 131 may determine the segments 142 and rules 145 that may apply to a determination of whether the content 150 is to be included in the contextual user interface 133 for the client 103. The content 150 may indicate the segments 142 of clients 103 that is to receive the content 150 in the contextual user interface 133. In this embodiment, the controller application 131 may also determine the rules 145 that may apply to whether the content 150 is to be included in the contextual interface 133 for the client 103.

In another embodiment, the controller application 131 may receive data regarding the segments 142 associated with the client 103 and the corresponding lists of segment-based content 146 from the server 109. A segment 142 may be associated with a client 103 when the identifiers of the clients stored in the segment 142 includes the identifier of the client 103, indicating the client 103 is part of the categorization or grouping of clients in the segment 143. The controller application 131 may receive data regarding the rules 145 associated with the client 103 (and in some cases the requested page) and the corresponding lists of rule-based content 147 from the server 109. A rule 145 may be associated with a client 103 when one or more conditions of the rule 145 relates to a state or attribute of the client 103. For example, a rule 145 regarding the display of a card 137 showing an account balance may be applicable to a client 103 when an account balance indicated in an account associated with the client 103 (e.g., state or attribute of the client 103) exceeds a threshold amount (e.g., related to a condition). In this embodiment, the controller application 131 may transmit a request for the segments 142 and the rules 145 applicable to the client 103 to the server 109. The server application 141 at the server 109 may identify the segments 142 including an identifier of the client and identify the rules 145 with conditions that relate to the states and attributes of the client 103. The server application 141 may also obtain the corresponding lists of segment-based content 146 and lists of rule-based content 147, and then provide the segments 142, rules 145, lists of segment-based content 146, and/or lists of rule-based content 147 back to the controller application 131.

At step 221, the controller application 131 may further process the content 150 based on the segments 142, rules 145, lists of segment-based content 146, and/or lists of rule-based content 147, by either filtering the content 150 received from the content server 112 or adding new content 150 from the content server 112. The controller application 131 may also further process the content 150 based on various types of data (e.g., user data 175).

In an embodiment, the controller application 131 may use the segments 142, rules 145, lists of segment-based content 146, and/or lists of rule-based content 147, in some cases, with the predictive model 136, to filter the content 150 received from the content server 112 for the page. First, the predictive model 136 may be used to determine the irrelevant content 150, or cards 137 that may not be relevant or likely to be consumed by the client 103, based on historical data associated with the user and/or client 103. In some cases, the segments 142, rules 145, lists of segment-based content 146, and lists of rule-based content 147 may also be used to determine the irrelevant content 150. The controller application 131 may discard the irrelevant content 150 (e.g., cards 137), or may prevent the irrelevant content 150 from being included in the contextual user interface 133 even when the irrelevant content 150 may be included in a baseline version of the requested page. For example, only the content 150 that is tagged with segments 142 that pertain to the client 103 (e.g., the user data 175 of the client 103 indicates that the client 103 is associated with the segment 142) may be included in a contextual user interface 133 for the client 103. Similarly, content 150 that is associated with certain rules 145 may only be displayed in the contextual user interface 133 for a client 103 when the conditions in the rules 145 are met or satisfied. In other words, when a rule 142 associated with the display of a card 137 requires the satisfaction of two conditions, both conditions may need to be met for the card 137 to be included in the contextual user interface 133 for a client 103.

Similarly, controller application 131 may use the segments 142, rules 145, lists of segment-based content 146, and lists of rule-based content 147, in some cases, with the predictive model 136, to identify additional content 150 to be received from the content server 112 for the contextual user interface 133. In this case, the controller application 131 may use the lists of segment-based content 146, lists of rule-based content 147, and/or any other content 150 determined using the predictive model 136 to identify additional content 150 to include in the contextual user interface 133. The additional content 150 may be relevant to the page (i.e., related to the general concept of the requested page) and also predicted to be consumed at the client 103 indicating an interest of the additional content 150 by the client 103.

After the controller application 131 has removed and added content 150 (e.g., cards 137) to the contextual user interface 133 for display at the client 103, the method may proceed to step 224. At step 224, the controller application 131 may generate initial parameters 226 for displaying the content 150 based on various factors, such as, for example, user data 175, a priority of each card 137, and/or the predictive model 136. The client data may be data describing the client 103 (e.g., type of device, identifier of the client 103, Mobile Station International Subscriber Directory Number (MSISDN), etc.). The user data may include personal information of the user (e.g., name, age, gender, occupation, etc.), account information (e.g., account number, subscription plans, billing information, etc.), and/or other information describing the user or user account. The priority of each card 137 may be preset by default based on a significance or impact of the data described in the card 137 (e.g., billing notification cards may have a higher priority than advertisement cards), or the priority of each card 137 may be determined, for example, using the predictive model 136, based on a likelihood of the user consuming or interacting with the card 137. The priority of each card 137 may also be set based on a tag or metadata of the card 137, which may be preset by the author of the card 137.

The initial parameters 226 may include a layout of the content 150 within the contextual user interface 133, the positioning of each card 137 within the layout, a size of each card 137, a color of each card 137, and/or any other visual element of the content 150 or each card 137 displayed in the contextual user interface 133. For example, each card 137 may represent a distinct piece of information of functionality, and the controller application 131 may determine the initial parameters 226 indicating the positioning, size, and/or color of each card 137 based on the priority of the cards 137 and/or using the predictive model 136. However, in some cases, certain visual elements of the content 150 or card 137 for display at the contextual user interface 133 may be determined at the client 103. This determination may be performed, for example, based on a contract between the client 103 and the content server. For example, the color, font, size, spacing, etc. of the cards 137 in the contextual user interface 133 may not be included in the initial parameters 226, but may instead be decided by the client 103 upon rendering the contextual user interface 133 based on, for example, the contract. At step 228, the controller application 131 may then transmit the processed content 150 with the initial parameters 226 to the client 103.

Referring now to FIG. 2B, shown is a message sequence diagram illustrating a second part of method 200 for generating the contextual user interface 133 and providing the contextual user interface 133 to the client 103. FIG. 2B is a continuation of the method 200 shown in FIG. 2A.

At step 230, after the client 103 has received the content 150 and the initial parameters 226 from the controller application 131, the client application 118 may initiate rendering of the contextual user interface 133 using the content 150 and the initial parameters 226. The client 103 may also obtain local data that may in some cases be used as part of the content 150 displayed in the contextual user interface 133. For example, some of the dynamic attributes 139 may be obtained from local data at the client 103 and input into the cards 137 for display in the contextual user interface 133. The client 103 may also obtain other data that may be used in the content 150. The client application 118 may include a rendering application used to render/generate/display the received content 150 according to the initial parameters 226.

At step 232, while the client 103 may be performing the initial rendering steps of the contextual user interface 133, the controller application 131 at the system 106 may begin the process of determining the dynamic attributes 130 in the content 150 provided to the client 103. In some cases, step 232 may be performed during step 221 of method 200 (shown in FIG. 2A). For example, each card 137 may include placeholders, metadata, or tags indicating the dynamic attributes 139 that may have to be included in the card 137 to complete presentation of the card, but may have to be obtained from an external source 115. The controller application 131 may identify the external source 115 from which the dynamic attributes 139 in the content 150 may be requested for the particular client 103.

At step 234, the controller application 131 may then receive the dynamic attributes 139 from one or more external sources 115. For example, the controller application 131 may transmit a request identifying the requested dynamic attributes 139 to each external source 115. The application 158 at the external sources 115 may obtain the dynamic attributes 139 from the data store 160, and transmit the dynamic attributes 139 back to the controller application 131. For example, the dynamic attributes 139 may refer to placeholders in the content 150, and a dynamic attribute 139 may be a string associated with a bill amount. The string dynamic attribute 139 may be obtained from the data store 160 and transmitted back to the controller application 131.

At step 236, the controller application 131 may generate rendering parameters 239 for the contextual user interface 133. For example, the rendering parameters 239 may include display instructions for the dynamic attributes 139 (e.g., the visual elements for the dynamic attributes 139) and/or other layout, size, color, shape, etc., and may include instructions for any of the other content 150 or cards 137 that may be included in the contextual user interface 133. The controller application 131 may package the dynamic attributes 139 with the rendering parameters 239, and at step 242, transmit the dynamic attributes 139 and the rendering parameters 239 to the client 103.

At step 245, the client application 118 may complete rendering of the contextual user interface 133 based on the received dynamic attributes 139 and the rendering parameters 239. For example, the client application 118 may input the dynamic attributes 139 into the cards 137 such that the dynamic attributes 139 (i.e., the user-specific data) are displayed at each of the cards 137 within the contextual user interface 133. The client 103 may complete rendering of the contextual user interface 133 such that the final contextual user interface 133 includes all of the processed content 150, ordered and presented according to the initial parameters 226 and rendering parameters 239. The contextual user interface 133 also includes all of the dynamic attributes 139 received from the external sources 115. The client application 118 may then display the contextual user interface 133 on the display 121 of the client 103 as the customized version of the requested page.

Referring now to FIG. 2C, shown is a message sequence diagram illustrating a method 250 for obtaining and processing content 150 to be included in the contextual user interface 133. Specifically, method 250 may be directed to processing the content 150 by filtering (or selecting) the content 150 to be received by the content server 112 for a requested page, thereby reducing the amount of data transmitted through the network 100 and back to the client 103.

At step 251, the controller application 131 at the system 106 may receive the content 150 to include in the contextual user interface 133 for a requested page. This step may be similar to steps 212 and 215 of method 200 in FIG. 2A. The controller application 131 may either determine and receive the content 150 for the requested page from the content server 112. The content 150 may include a first quantity 253 of cards 137, which in some cases may be based on preset cards 137 associated with the requested page, as mentioned above.

At step 256, the controller application 131 may identify the segments 142, rules 145, lists of segment-based content 146, and/or lists of rule-based content 147 applicable to the client 103 and/or the requested page. This step may be similar to steps 215 and 218 of method 200 in FIG. 2A, in which the controller application 131 determines the segments 142, rules 145, lists of segment-based content 146, and/or lists of rule-based content 147 applicable to the content 150, client 103, and/or the requested page. In one embodiment, the controller application 131 may identify the segments 142 that are tagged in each of the cards 137 of the content 150, and then select only the cards 137 that identify segments 142 including the client 103. In this embodiment, the controller application 131 may also identify the rules 145 applicable to the cards 137 in the content 150, and then only select the cards 137 that meet the conditions of the applicable rules 145 based on the requested page and the client 103.

In another embodiment, the server application 141 at the server 109 may receive a request from the controller application 131 including the identifier of the client 103 and an indication/identifier of the requested page. The server application 141 may retrieve the segments 142, rules 145, lists of segment-based content 146, and/or lists of rule-based content 147 applicable to the client 103 and/or the requested page from the data store 140, package the segments 142, rules 145, lists of segment-based content 146, and/or lists of rule-based content 147 together for transmission back to the controller application 131 for identification.

At step 259, the controller application 131 may filter the determined content 150, in some cases using the predictive model 136, and based on the applicable segments 142, rules 145, lists of segment-based content 146, and/or lists of rule-based content 147 to obtain filtered content 260. This step may in some cases be performed similar to step 221 of method 200 in FIG. 2A. In one embodiment, only the cards 137 that identify segments 142 including the client 103 may be selected for inclusion in the filtered content 260. The remaining cards 137 that do not identify segments 142 including the client 103 may be removed/discarded, and not included in the filtered content 260. Similarly, only the cards 137 that meet the conditions of the applicable rules 145 based on the requested page and the client 103 may be selected for inclusion in the filtered content 260. The remaining cards 137 that do not meet the conditions of the applicable rules 145 may be removed/discarded, and not included in the filtered content 260.

In another embodiment, the segments 142 and lists of segment-based content 146 may indicate the type of content 150 (e.g., cards 137) that may be the most relevant to the user and/or client 103 based on a categorical grouping of the user and/or client 103. Similarly, the rules 145 and/or lists of rule-based content 147 may indicate the type of content 150 (e.g., cards 137) that is most relevant to the user and/or client 103 based on a state and/or attributes of the user and/or client 103. The predictive model 136 may be trained to further predict whether certain types of content 150 (e.g., cards 137) are likely to be relevant and interesting to the user, and thus may be included in the contextual user interface 133 or should be excluded from the contextual user interface 133. For example, the predictive model 136 may be trained with user data, client data, historical data, etc., as further described above, to identify trends in the content 150 relevant to and consumed by the client 103.

The controller application 131 may filter the content 150 by determining, for example, which cards 137 to exclude from the contextual user interface 133 based on the segments 142, rules 145, lists of segment-based content 146, and lists of rule-based content 147, and in some cases using the predictive model 136. For example, controller application 131 may remove certain cards 137 from the content 150 based on a determination that the removed cards 137 are unlikely to be relevant or consumed by the client 103, to obtain a subset 262 of cards 137. For example, cards 137 pertaining to certain types of devices may be excluded from the contextual user interface 133 when the client 110 has never interacted with advertisements or pages related to those types of devices. In this way, the cards 137 in the subset 262 may be ones that are considered relevant to the page and/or client 110 such that only the cards 137 in the subset 262 may be included in the contextual user interface 133. The filtered content 260 may include the subset 262 of cards 137 of a second quantity 263, in which the second quantity 263 may be less than the first quantity 253 of the cards 137 (i.e., since certain irrelevant cards 137 were filtered out).

At step 269, the controller application 131 may determine the dynamic attributes 139 in the filtered content 260 (across all of the subset 262 of cards 137) that are to be obtained from different external sources 115. This step may be performed similar to step 232 of method 200 in FIG. 2B, except that the dynamic attributes 139 are the attributes from the filtered content 260 (e.g., including the subset 262 of cards 137). The controller application 131 may in some cases consolidate the dynamic attributes 139 across all of the different cards 137 when multiple cards 137 have overlapping dynamic attributes 139, which may be used differently for the different cards, but may be the same for a single client 103. For example, multiple cards 137 in the subset 262 may include the same dynamic attributes 139, which may include text describing a demographic of the user operating the client 103. The controller application 131 may determine that multiple cards 137 include a common dynamic attribute 139. However, some of the cards 137 may indicate different external sources 115 from which the dynamic attribute 139 may be received.

At step 271, the controller application 131 may receive the common dynamic attribute 139 from only one of the external sources 115 (i.e., instead of receiving the common dynamic attribute 139 from multiple different external sources 115). This step may be performed similar to step 234 of method 200 in FIG. 2B. By consolidating the process of retrieving common dynamic attributes 139 for the filtered content 260, the load on the network 100 may be significantly reduced since the redundant transmissions of the common dynamic attribute 139 from the external sources 115 to the system 106 can be reduced.

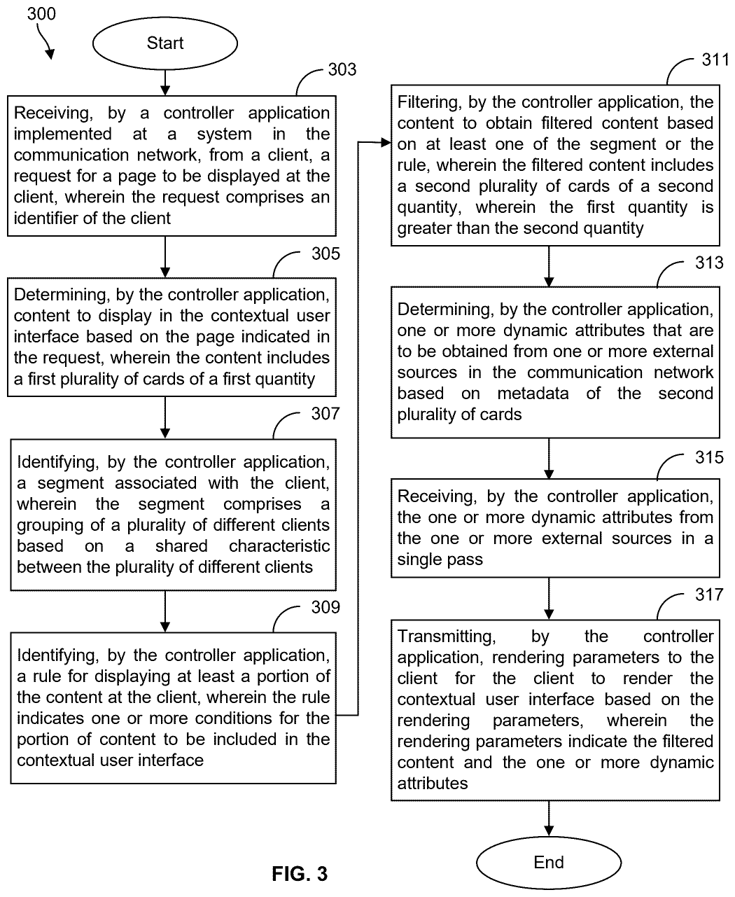

Referring now to FIG. 3, shown is a method 300 for providing a contextual user interface 133 to a client 103. The method 300 may be implemented by the controller application 131 in the system 106. The method 300 may be implemented after the client 103 has been authenticated by, for example, an application server or the system 106, to provide contextual user interfaces 133 to the client 103.

At step 303, method 300 may comprise receiving, by a controller application 131 implemented at a system 106 in the communication network 100, from a client 103, a request for a page to be displayed at the client 103. The request comprises an identifier of the client 103. At step 305, method 300 may comprise determining, by the controller application 131, content 150 to display in the contextual user interface 133 based on the page indicated in the request. The content 150 comprises one or more cards 137 of a first quantity 253.

At step 307, method 300 may comprise identifying, by the controller application 131, a segment 142 associated with the client 103. The segment 142 comprises a grouping of a plurality of different clients based on a shared characteristic between the plurality of different clients. At step 309, method 300 may comprise identifying, by the controller application 131, a rule 145 for displaying at least a portion of the content 150 at the client 103. The rule indicates one or more conditions for the portion of content 150 to be included in the contextual user interface 133.

At step 311, method 300 may comprise filtering, by the controller application 131, the content 150 to obtain filtered content 260 based on at least one of the segment 142 or the rule 145. The filtered content 260 includes a second plurality of cards 137 of a second quantity, wherein the first quantity is greater than the second quantity 263. In an embodiment, to filter the content 150, the controller application 131 may select a subset 262 of the cards 137 ((i.e., second plurality of cards 137) that are likely to be relevant and consumed at the client 103 based on at least one of the segment 142 or the rule 145 (e.g., by removing the cards 137 that are unlikely to be relevant or consumed by the client 103). At step 313, method 300 may comprise determining, by the controller application 131, one or more dynamic attributes 139 that are to be obtained from one or more external sources 115 in the communication network 100 based on metadata of the second plurality of cards 137. At step 315, method 300 may comprise receiving, by the controller application 131, the one or more dynamic attributes 139 from the one or more external sources 115 in a single pass. For example, the controller application 131 may receive a common dynamic attribute 139 indicated in multiple cards 137 from a single external source 115 (e.g., as opposed to from multiple different external sources 115 as may have been indicated in the metadata of the cards 137). At step 317, method 300 may comprise transmitting, by the controller application 131, rendering parameters 239 to the client 103 for the client 103 to render the contextual user interface 133 based on the rendering parameters 239. The rendering parameters 239 indicate the filtered content 260 and the one or more dynamic attributes 130.

Method 300 may include other steps and/or features that are not otherwise shown in FIG. 3. In an embodiment, the content 150 comprises a card 137, the card 137 comprises an identifier of the segment 142, and the user data 175 associated with the client 103 also comprises the identifier of the segment 142. In an embodiment, the segment 142 includes a plurality of clients categorically grouped together. For example, each segment 142 may include a grouping of clients that have similar attributes, features, or interests, which may be indicated in a behavior or consumption history of the client or may be indicated in an account of the client. In an embodiment, the second plurality of cards 137 in the filtered content 260 comprises a first card 137 and a second card 137, in which the first card 137 and the second card 137 both include a common dynamic attribute 139 for the client 103. In an embodiment, receiving, by the controller application 131, the one or more dynamic attributes 139 from the one or more external sources 115 in the single pass comprises receiving, by the controller application 131, the common dynamic attribute 139 from a single external source 115 at one time, such that the common dynamic attribute 139 is used for both the first card 137 and the second card 137.

In an embodiment, the filtering, by the controller application 131, the content 150 to obtain the filtered content 260 based on the segment 142 comprises determining, by the controller application 131, one or more cards 137 to be included in the contextual user interface 133 for the client 103 based on a segment 142 identified in the one or more cards 137, and selecting, by the controller application 131, the one or more cards 137 to include in the contextual user interface 133. In an embodiment, the filtering, by the controller application 131, the content 150 to obtain the filtered content 260 comprises identifying, by the controller application 131, a rule 145 for displaying at least a portion of the content 150 at the client 103, wherein the rule 145 indicates one or more conditions for the portion of content 150 to be included in the contextual user interface 133, determining, by the controller application 131, one or more cards 137 to be included in the contextual user interface 133 for the client 103 based on a rule 145 applicable to the one or more cards 137, wherein the rule 145 comprises a condition that is to be satisfied for the one or more cards 137 to be included in the contextual user interface 133, and selecting, by the controller application 131, the one or more cards 137 to include in the contextual user interface 133 when the condition is satisfied.

In an embodiment, method 300 may further comprise determining, by the controller application 131, a layout of the second plurality of cards 137 in the contextual user interface 133 based on a priority of each of the second plurality of cards 137. In an embodiment, at least one of a size, color, or positioning of each of the second plurality of cards 137 is based on the priority of each of the second plurality of cards 137. In an embodiment, the priority of each of the second plurality of cards 137 is included in the metadata of each of the second plurality of cards.

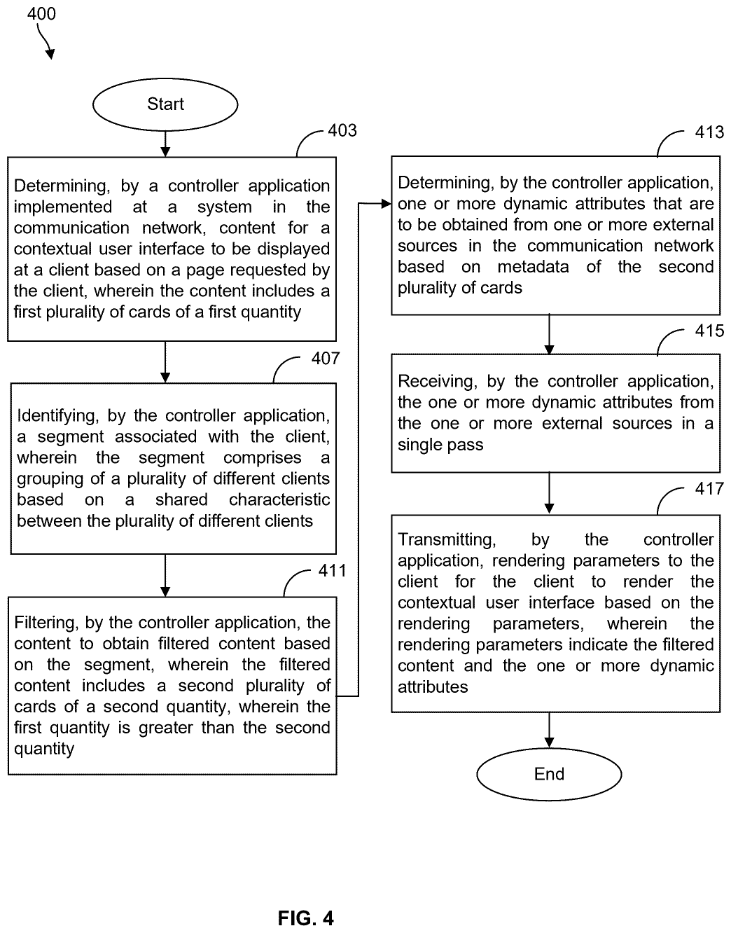

Referring now to FIG. 4, shown is a method 400 for providing a contextual user interface 133 to a client 103. The method 400 may be implemented by the controller application 131 in the system 106. The method 400 may be implemented after the client 103 has been authenticated by, for example, an application server or the system 106, to provide contextual user interfaces 133 to the client 103.

At step 403, method 400 may comprise determining, by a controller application 131 implemented at a system 106 in the communication network 100, content 150 for a contextual user interface 133 to be displayed at a client 103 based on a page requested by the client 103. The content 150 may include a first plurality of cards 137 of a first quantity 253. At step 407, method 400 may comprise identifying, by the controller application 131, a segment 142 associated with the client 103, in which the segment 142 comprises a grouping of a plurality of different clients based on a shared characteristic between the plurality of different clients. At step 411, method 400 may comprise filtering, by the controller application 131, the content 150 to obtain filtered content 260 based on the segment 142. The filtered content 260 includes a second plurality of cards 137 of a second quantity 263, in which the first quantity 253 is greater than the second quantity 263. In an embodiment, to filter the content 150, the controller application 131 may select a subset 262 of the cards 137 (i.e., second plurality of cards 137) that are likely to be relevant and consumed at the client 103 based on the segment 142 (e.g., by removing the cards 137 that are unlikely to be relevant or consumed by the client 103).

At step 413, method 400 may comprise determining, by the controller application 131, one or more dynamic attributes 139 that are to be obtained from one or more external sources 115 in the communication network 100 based on metadata of the second plurality of cards 137. At step 415, method 400 may comprise receiving, by the controller application 131, the one or more dynamic attributes 139 from the one or more external sources 115 in a single pass. At step 417, method 400 may comprise transmitting, by the controller application 131, rendering parameters 239 to the client 103 for the client 103 to render the contextual user interface 133 based on the rendering parameters 239. The rendering parameters 239 indicate the filtered content 260 and the one or more dynamic attributes 130.

Method 400 may include other steps and/or features that are not otherwise shown in FIG. 3. In an embodiment, the page is at least one of a webpage or application to be displayed at the client 103, and determining the content 150 to display in the contextual user interface 133 is further based on the at least one of the webpage or the application. In an embodiment, the method 300 may further comprise storing, at a data store 140 in a server implemented in the communication network 100, the segment 142 in association with a list of segment-based content 146 and the rule 145 in association with a list of rule-based content 147.

In an embodiment, the second plurality of cards 137 in the filtered content 260 comprises a first card 137 and a second card 137, in which the first card 137 and the second card 137 both include a common dynamic attribute 139 for the client 103. In an embodiment, receiving, by the controller application 131, the one or more dynamic attributes 139 from the one or more external sources 115 in the single pass comprises receiving, by the controller application 131, the common dynamic attribute 139 from a single external source 115 at one time, such that the common dynamic attribute 139 is used for both the first card 137 and the second card 137.

In an embodiment, the filtering, by the controller application 131, the content 150 to obtain the filtered content 260 based on the segment 142 comprises determining, by the controller application 131, one or more cards 137 to be included in the contextual user interface 133 for the client 103 based on a segment 142 identified in the one or more cards 137, and selecting, by the controller application 131, the one or more cards 137 to include in the contextual user interface 133. In an embodiment, the filtering, by the controller application 131, the content 150 to obtain the filtered content 260 based on the segment 142 comprises identifying, by the controller application, a rule 145 for displaying at least a portion of the content 150 at the client 103, wherein the rule 145 comprises a condition that is to be satisfied for the content 150 to be included in the contextual user interface 137, determining, by the controller application 131, one or more cards 137 to be included in the contextual user interface 133 for the client 103 based on the rule applicable to the one or more cards, and obtaining, by the controller application 131, the one or more cards 137 to include in the contextual user interface 133 when the condition is satisfied.

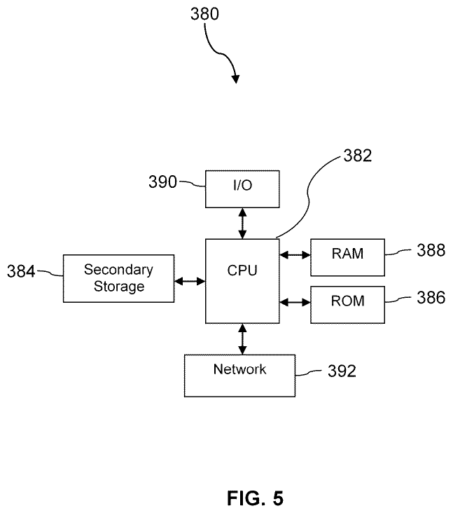

FIG. 5 illustrates a computer system 380 suitable for implementing one or more embodiments disclosed herein. In an embodiment, client 103 and/or system 106 may each be implemented as the computer system 380. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to provide a contextual user interface to a client, wherein the method comprises:
receiving, by a controller application implemented at a system in the communication network, from a client, a request for a page to be displayed at the client, wherein the request comprises an identifier of the client;
determining, by the controller application, content to display in the contextual user interface based on the page indicated in the request, wherein the content includes a first plurality of cards of a first quantity;
identifying, by the controller application, a segment associated with the client, wherein the segment comprises a grouping of a plurality of different clients based on a shared characteristic between the plurality of different clients;
identifying, by the controller application, a rule for displaying at least a portion of the content at the client, wherein the rule indicates one or more conditions for the portion of content to be included in the contextual user interface;
filtering, by the controller application, the content to obtain filtered content based on at least one of the segments or the rule, wherein the filtered content includes a second plurality of cards of a second quantity, wherein the first quantity is greater than the second quantity;
determining, by the controller application, one or more dynamic attributes that are to be obtained from one or more external sources in the communication network based on metadata of the second plurality of cards;
receiving, by the controller application, the one or more dynamic attributes from the one or more external sources in a single pass; and
transmitting, by the controller application, rendering parameters to the client for the client to render the contextual user interface based on the rendering parameters, wherein the rendering parameters indicate the filtered content and the one or more dynamic attributes.

2. The method of claim 1, wherein the page is at least one of a webpage or application to be displayed at the client, and wherein determining the content to display in the contextual user interface is further based on the at least one of the webpages or the application.

3. The method of claim 1, wherein the content comprises a card, wherein the card comprises an identifier of the segment, wherein user data associated with the client also comprises the identifier of the segment.

4. The method of claim 1, wherein the second plurality of cards in the filtered content comprises a first card and a second card, wherein the first card and the second card both include a common dynamic attribute for the client, and wherein receiving, by the controller application, the one or more dynamic attributes from the one or more external sources in the single pass comprises receiving, by the controller application, the common dynamic attribute from a single external source at one time, such that the common dynamic attribute is used for both the first card and the second card.

5. The method of claim 1, wherein filtering, by the controller application, the content to obtain the filtered content based on the segment comprises:
determining, by the controller application, one or more cards to be included in the contextual user interface for the client based on a segment identified in the one or more cards; and
selecting, by the controller application, the one or more cards to include in the contextual user interface.

6. The method of claim 1, wherein filtering, by the controller application, the content to obtain the filtered content based on the rule comprises:
determining, by the controller application, one or more cards to be included in the contextual user interface for the client based on a rule applicable to the one or more cards, wherein the rule comprises a condition that is to be satisfied for the one or more cards to be included in the contextual user interface; and
selecting, by the controller application, the one or more cards to include in the contextual user interface when the condition is satisfied.

7. The method of claim 1, further comprising determining, by the controller application, a layout of the second plurality of cards in the contextual user interface based on a priority of each of the second plurality of cards.

8. The method of claim 7, wherein at least one of a size, color, or positioning of each of the second plurality of cards is based on the priority of each of the second plurality of cards.

9. The method of claim 7, wherein the priority of each of the second plurality of cards is included in the metadata of each of the second plurality of cards.

10. A method implemented in a communication network to provide a contextual user interface to a client, wherein the method comprises:
determining, by a controller application implemented at a system in the communication network, content for a contextual user interface to be displayed at a client based on a page requested by the client, wherein the content includes a first plurality of cards of a first quantity;
identifying, by the controller application, a segment associated with the client, wherein the segment comprises a grouping of a plurality of different clients based on a shared characteristic between the plurality of different clients;
filtering, by the controller application, the content to obtain filtered content based on the segment, wherein the filtered content includes a second plurality of cards of a second quantity, wherein the first quantity is greater than the second quantity;
determining, by the controller application, one or more dynamic attributes that are to be obtained from one or more external sources in the communication network based on metadata of the second plurality of cards;
receiving, by the controller application, the one or more dynamic attributes from the one or more external sources in a single pass; and
transmitting, by the controller application, rendering parameters to the client for the client to render the contextual user interface based on the rendering parameters, wherein the rendering parameters indicate the filtered content and the one or more dynamic attributes.

11. The method of claim 10, wherein the segment includes a plurality of clients categorically grouped together.

12. The method of claim 10, wherein the second plurality of cards in the filtered content comprises a first card and a second card, wherein the first card and the second card both include a common dynamic attribute for the client, and wherein receiving, by the controller application, the one or more dynamic attributes from the one or more external sources in the single pass comprises receiving, by the controller application, the common dynamic attribute from a single external source at one time, such that the common dynamic attribute is used for both the first card and the second card.

13. The method of claim 10, wherein filtering, by the controller application, the content to obtain the filtered content based on the segment comprises:
determining, by the controller application, one or more cards to be included in the contextual user interface for the client based on a segment identified in the one or more cards; and
selecting, by the controller application, the one or more cards to include in the contextual user interface.

14. The method of claim 10, further comprising:
identifying, by the controller application, a rule for displaying at least a portion of the content at the client, wherein the rule comprises a condition that is to be satisfied for the one or more cards to be included in the contextual user interface;
determining, by the controller application, one or more cards to be included in the contextual user interface for the client based on the rule applicable to the one or more cards; and
selecting, by the controller application, the one or more cards to include in the contextual user interface when the condition is satisfied.

15. A system, comprising:
at least one data store configured to store a parameter;
at least one processor;
at least one memory coupled to the processor;
a controller application, stored in the at least one memory, which when executed by the at least one processor, causes the controller application to be configured to:
determine content for a contextual user interface to be displayed at a client based on a page requested by the client, wherein the content includes a first plurality of cards of a first quantity;
identify a segment associated with the client, wherein the segment comprises a grouping of a plurality of different clients based on a shared characteristic between the plurality of different clients;
filter the content to obtain filtered content based on the segment, wherein the filtered content includes a second plurality of cards of a second quantity, wherein the first quantity is greater than the second quantity;
determine one or more dynamic attributes that are to be obtained from one or more external sources based on metadata of the second plurality of cards;
receive the one or more dynamic attributes from the one or more external sources in a single pass; and
transmit rendering parameters to the client for the client to render the contextual user interface based on the rendering parameters, wherein the rendering parameters indicate the filtered content and the one or more dynamic attributes.

16. The system of claim 15, wherein the segment includes a plurality of clients categorically grouped together.

17. The system of claim 15, wherein the second plurality of cards in the filtered content comprises a first card and a second card, wherein the first card and the second card both include a common dynamic attribute for the client, and wherein the controller application is further configured to receive the common dynamic attribute from a single external source at one time, such that the common dynamic attribute is used for both the first card and the second card.

18. The system of claim 15, wherein the filter the content to obtain the filtered content based on the segment, the controller application is further configured to:
determine one or more cards to be included in the contextual user interface for the client based on a segment identified in the one or more cards; and
select the one or more cards to include in the contextual user interface.

19. The system of claim 15, wherein the controller application is further configured to identify a rule for displaying at least a portion of the content at the client, wherein the rule comprises a condition that is to be satisfied for the one or more cards to be included in the contextual user interface.

20. The system of claim 18, wherein the controller application is further configured to:
determine one or more cards to be included in the contextual user interface for the client based on the rule applicable to the one or more cards; and
select the one or more cards to include in the contextual user interface when the condition is satisfied.
